(19) United States
(12) Patent Application Publication
(10) Pub. No.: US 2026/0056375 A1
(43) Pub. Date: Feb. 26, 2026

(54) OPTICAL CHIP-FIBER COUPLER BASED ON THROUGH-SUBSTRATE COLLIMATING GRATING

(71) Applicant: Lightip Technologies Co. Ltd., Hangzhou (CN)

(72) Inventors: Qiaoli LI, Hangzhou (CN); Hao LIU, Hangzhou (CN); Jianjun HE, Hangzhou (CN)

(73) Assignee: Lightip Technologies Co. Ltd., Hangzhou, ZJ (CN)

(21) Appl. No.: 19/372,217

(22) Filed: Oct. 28, 2025

(30) Foreign Application Priority Data
Nov. 26, 2024 (CN) 202411703758.1

(51) Int. Cl. G02B 6/42

(52) U.S. Cl. CPC G02B 6/4206; G02B 6/4214; G02B 6/4245; G02B 6/4261

(57) ABSTRACT

An optical chip-fiber coupler based on a through-substrate collimating grating, comprising:; a flip-chip mounted optical chip comprising at least one optical device, an optical waveguide array, and a collimating grating array, wherein the collimating grating array is provided with gradient periods and duty cycles, so that light output from the optical waveguide array is diffracted toward the substrate through the collimating grating array, and the light propagates to a back surface of the optical chip in a substantially collimated manner. An optical coupling element array is arranged on the back surface of the optical chip at positions corresponding to light emission from the collimating grating array to couple the light to an optical fiber array. This structure achieves high-efficiency coupling between optical chips and optical fiber arrays and can be widely applied in fields such as optical IO and CPO for large-scale optoelectronic integrated chips.

### TECHNICAL FIELD

The present disclosure relates to the technical field of optoelectronic chips, particularly to an optical chip-fiber coupler based on a through-substrate collimating grating.

### BACKGROUND

The current data center/intelligent computing system is composed of thousands of servers interconnected via optical fiber networks. With the exponential growth of switching bandwidth, pluggable optical modules will be gradually replaced by Co-Packaged Optics (CPO). CPO integrates multiple optical chips and electrical chips on a single substrate, which reduces radio frequency losses between optoelectronic chips, improves signal quality, and significantly enhances the system integration degree and edge switching bandwidth density. Nevertheless, the optical interface of CPO requires a substantially increased number of optical fibers, and the coupling complexity between optical chips and fiber arrays has also risen significantly. This makes conventional optical connectors that rely on fiber array jumpers (such as multi-fiber push-on (MPO)) increasingly inadequate. To satisfy the ultra-high-density fiber connectivity requirements of CPO, the industry has begun researching novel optical interfaces where fiber connectors are directly coupled to optical chips while the optical connector maintains pluggability. Nevertheless, existing technical solutions still face challenges such as high process complexity and low precision tolerance.

For example, in the document Detachable Optical Chiplet Connector for Co-Packaged Photonics, Intel proposes using glass to fabricate an optical bridge interface which is integrated with a silicon photonic chip to couple light out of the silicon photonic chip. The optical bridge interface features a passive alignment structure, and the fiber array has a matching passive alignment structure, enabling direct passive alignment and coupling during insertion, secured by a mechanical structure, with an average coupling loss of 1.41 dB. However, the glass bridge interface in this solution is challenging to manufacture and costly.

In Patent US20230251428A1, Broadcom International Pte. Ltd. proposes attaching lens arrays to the light-emitting side of the silicon optical chip and the end face of the fiber array for coupling, relying on an external mechanical structure to achieve passive alignment during fiber array insertion. This solution requires high process precision for lens attachment on the light-emitting side of chips and has a small end-face coupling alignment tolerance.

In the document Detachable Interface Toward a Low-Loss Reflow-Compatible Fiber Coupling for Co-Packaged Optics (CPO), InnoLight Technology (Suzhou) Ltd. proposes using two mating connectors, each equipped with a microlens array, for coupling. The connectors are deposited on the substrate and in front of the fiber array, respectively, achieving a coupling loss of less than 1 dB. This solution is similar to conventional coupling principles, but involves a complex process, small end-face coupling alignment tolerance, and a relatively large overall size.

### SUMMARY

An objective of the present disclosure is to provide an optical chip-fiber coupler based on a through-substrate collimating grating, which implements an optical interface, and to provide a through-substrate chirped collimating grating for coupling between optical fiber and optical chip. The grating or grating array is used together with a total internal reflection microprism and a microlens array to collimate light beams into parallel light for coupling, thereby solving the problems of low coupling efficiency and small alignment tolerance in conventional grating coupling or end-face coupling. The optical interface on this configuration enables pluggable and efficient coupling between the fiber array and the optical chip. By coupling light from the back surface of the optical chip, the optical device layout of the flip-chip mounted optical chip on the fan-out substrate is not constrained by the positions of light output ports or electrical interfaces, allowing free two-dimensional array arrangement. Both the edge density of the optical chip coupled fiber and the integration degree of the optical chip are improved.

To achieve the above objective, the present disclosure provides an optical chip-fiber coupler based on through-substrate collimating grating, including: a package substrate; a flip-chip mounted optical chip is arranged on the package substrate, the optical chip includes at least one optical device, an optical waveguide array for input and output functions, and a collimating grating array, wherein the collimating grating array is provided with gradient periods and duty cycles, so that the light output from the optical waveguide array is diffracted toward the substrate through the collimating grating array, and the light propagates to a back surface of the optical chip in a collimated manner with a large spot size, thereby offering a large coupling tolerance, and an optical coupling element array is arranged on the back surface of the optical chip at positions corresponding to light emission from the collimating grating array to couple the light to an optical fiber array;

the optical chip and the optical fiber array include a horizontal coupling relationship, the optical coupling element array includes a total internal reflection microprism and a microlens array arranged on a light emission path of the total internal reflection microprism;

the optical coupling element array and optical fiber array may be connected to the package substrate through a mechanical structure, and the mechanical structure includes an optical fiber connector arranged outside the optical fiber array and an optical interface socket on the package substrate;

the optical fiber connector may be detachably connected to the optical interface socket, the large coupling tolerance of the collimating grating array allows the optical chip-fiber coupler to tolerate a large position error of the optical fiber array when the fiber connector is detachably connected to the optical interface socket.

In some embodiments, the microlens array corresponds to the optical fiber array and is configured as a single unit, a one-dimensional array, or a two-dimensional array.

In some embodiments, the package substrate is made of Si, quartz, glass, ceramic or organic material, wherein multiple electrical chips are arranged on the package substrate.

In some embodiments, when the optical fiber connector is inserted, a positional

error of the optical fiber array satisfies a coupling tolerance with the collimating grating array.

In some embodiments, the material of the optical chip is configured as InP, SOI, SiN, or thin-film lithium niobate (TFLN), types of optical devices include lasers, optical amplifiers, optical modulators, optical detectors, and multiplexers/demultiplexers, a back surface of the optical chip substrate is coated with an optical antireflection film.

In some embodiments, the collimating grating array is configured as a one-dimensional array or a two-dimensional array, wherein the collimating grating array is specifically a chirped grating, a gradient grating coupling coefficient is obtained by optimizing a grating etching depth and the gradient duty cycle, thereby enabling the coupled outgoing or incident light to exhibit a specific optical field distribution.

In some embodiments, a metal high-reflection film is deposited on the surface of an upper cladding layer of the collimating grating array as a metal reflector, a distance between the metal high-reflection film and the collimating grating is adjusted, so that the light diffracted from the collimating grating array to the upper cladding and reflected by the metal high-reflection film and then penetrated the collimating grating array constructively interfere with the light diffracted directly downward to the substrate by the collimating grating array.

In some embodiments, the material of the total internal reflection microprism is Si, quartz or glass, the reflection surface of the total internal reflection microprism is arranged at a hypotenuse and totally reflects light, an angle of the hypotenuse satisfies a condition that the light emission from the collimating grating array is steered to be parallel to a plane of the optical chip and aligned with the optical fiber array; the two right-angle sides of the total internal reflection microprism are coated with optical antireflection films, and a projection area of the total internal reflection microprism along the light beam propagation direction covers the collimating grating array.

In some embodiments, the microlens array is attached to an end face of the optical fiber array or arranged on the total internal reflection microprism, and the microlens array focuses and couples the collimated light emitted from the optical chip into the optical fiber array.

In some embodiments, the microlens array is integrally fabricated on the back surface of the optical chip substrate, and the microlens array focuses and couples the collimated light emitted from the optical chip into the optical fiber array.

Therefore, the present disclosure adopts the above-mentioned optical chip-fiber coupler based on through-substrate collimating grating, which has the following advantages:

the optical chip-fiber coupler based on the through-substrate collimating grating provided by the present disclosure collimates the outgoing or incident light of the optical chip into parallel light coupling of a large spot, the coupling efficiency and alignment tolerance are significantly improved compared with the conventional grating coupler and the edge coupler, the mechanical positioning accuracy requirement of the pluggable optical fiber array coupling is relaxed, so that the pluggable optical interface easily achieved. Moreover, the optical coupler of the present disclosure can adopt a two-dimensional collimating grating array and a two-dimensional optical fiber array, thereby significantly improving the edge density of the coupling optical fiber of the optical chip. Additionally, the through-substrate collimating grating makes light input/output from the back surface of the optical chip, while the electrical interface of the optical chip is on the front surface of the chip, therefore the two will not affect each other in space, so that the optical chip can be flip-chip mounted on the package substrate for fan-out packaging without being constrained by the position of the optical output. Accordingly, the optical devices of the optical chip can be freely arranged into a two-dimensional array without being constrained by the position of the optical output and the position of the electrical interface, and the integration degree of the optical chip can be improved. The optical chip-fiber coupler and the optical interface socket on the through-substrate collimating grating of the present disclosure can simplify the complex optical coupling packaging process and facilitate its application in the fields of optical input/output (IO), CPO and the like.

Further detailed descriptions of the technical scheme of the present disclosure can be found in the accompanying drawings and embodiments.

### BRIEF DESCRIPTION OF THE DRAWINGS

FIG. 1 is a sectional view of an optical chip-fiber coupler based on a through-substrate collimating grating of embodiment 1 of the present disclosure;

FIG. 2 is a schematic diagram of a top-view structure of an optical chip of an optical chip-fiber coupler based on a through-substrate collimating grating of embodiment 1 of the present disclosure;

FIG. 3 is a schematic diagram of a collimated optical coupling optical path of an optical chip-fiber coupler based on a through-substrate collimating grating of embodiment 1 of the present disclosure;

FIG. 4 is a schematic diagram of a pluggable coupling process of an optical chip-fiber coupler based on through-substrate collimating grating of the present disclosure, wherein FIG. 4 (a) is a schematic diagram before mounting, and FIG. 4 (b) is a schematic diagram after mounting;

FIG. 5 is a schematic diagram of an optical interface array of an optical chip-fiber coupler based on a through-substrate collimating grating of the present disclosure;

FIG. 6 is a schematic diagram of an optical chip-fiber coupler based on a through-substrate collimating grating of embodiment 2 of the present disclosure;

FIG. 7 is a schematic diagram of an optical chip-fiber coupler based on a through-substrate collimating grating of embodiment 3 of the present disclosure;

Reference numerals in figures: 100, an optical chip; 101, a collimating grating array; 102, an optical waveguide; 103, a optical device; 104, a metal reflector; 105, a substrate; 200, a total internal reflection microprism; 300, an optical fiber connector; 301, an optical fiber array; 302, a microlens array; 400, an optical interface socket; 500, a package substrate; 501, an electrical chip.

### DETAILED DESCRIPTION OF THE EMBODIMENTS

In order to make the objectives, the technical solutions, and the advantages of the present disclosure clearer, the following clearly and completely describes the technical solutions in embodiments of the present disclosure with reference to the drawings of embodiments of the present disclosure. Apparently, the described embodiments are only some but not all of the embodiments of the present disclosure. 28. The components of the embodiments of the present disclosure described and shown in the accompanying drawings may be arranged and designed in various different configurations. The specific model specifications shall be selected and determined based on the actual specifications of the device. The specific selection and calculation structure adopts the existing technology in the field, so it will not be described in detail here.

### Embodiment 1

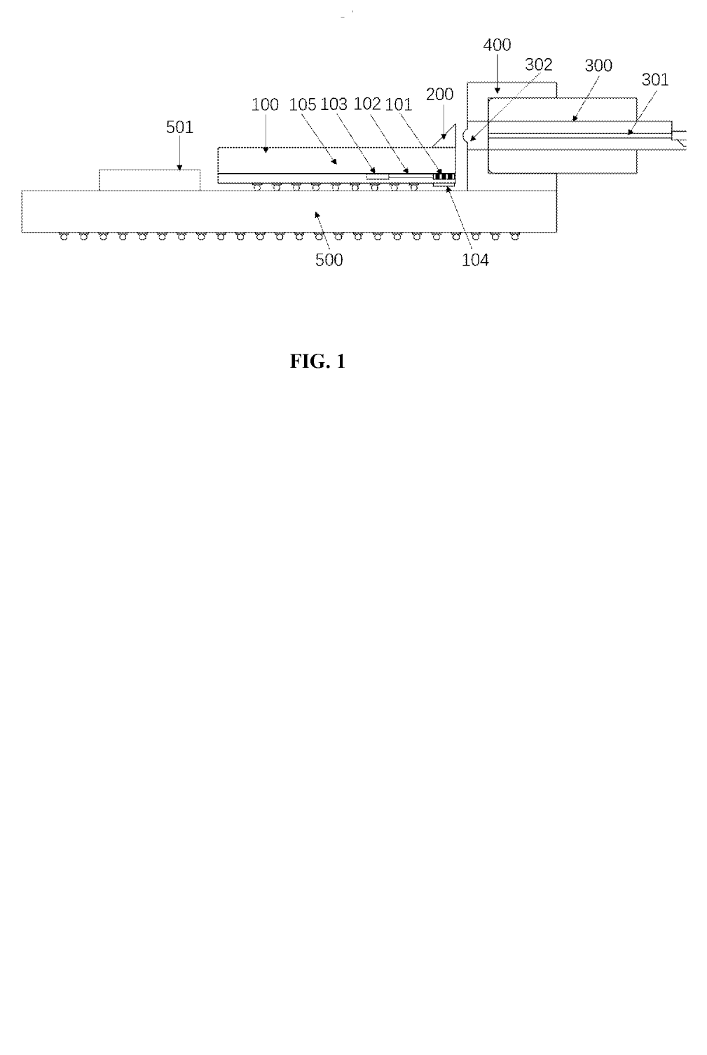

As shown in FIGS. 1-5, the present disclosure provides an optical chip-fiber coupler based on through-substrate collimating grating, specially shown in FIG. 1, including the optical chip 100, the total internal reflection microprism 200, the optical fiber connector 300, the optical interface socket 400, the package substrate 500 and the electric chip 501. Wherein optical chip 100 is fabricated with the collimating grating array 101, the optical waveguide 102, the optical device 103, the metal reflector 104, and the substrate 105, while the optical fiber connector 300 is provided with the optical fiber array 301 and the microlens array 302.

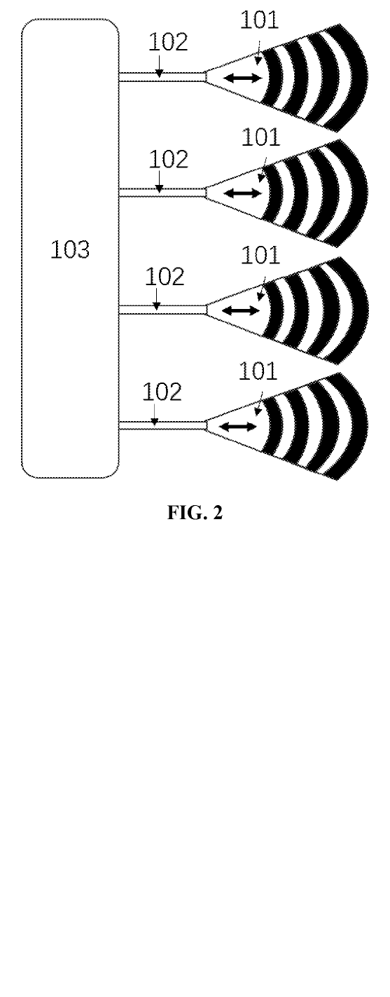

The collimating grating array 101 is fabricated within the optical chip 100. The material of the optical chip 100 may be InP, SOI, SiN, TFLN, etc. The optical chip 100 includes the optical waveguide 102 and at least one of the optical devices 103, such as the laser, the optical amplifier, the optical modulator, the optical detectors, and the multiplexers/demultiplexers. The collimating grating array 101 may be connected to these optical devices via the optical waveguide 102, and the specific connection method is shown in FIG. 2. The light output from the output optical waveguide 102 is diffracted by the collimating grating array 101 into collimated light, and then transmitted through the substrate 105 to the back surface of the optical chip 100. To reduce reflections from the back surface of the optical chip 100, the back surface of the optical chip 100 is coated with the optical antireflection film.

The collimating grating array 101 is designed as a chirped collimating grating array using the apodization method, and the gradient grating coupling coefficient is obtained by optimizing the grating etching depth and the gradient duty cycle, thereby enabling the coupled outgoing or incident light to exhibit the specific optical field distribution. The diffraction light field on the grating, which originally decreases exponentially along the waveguide propagation direction, is tailored into a shape close to Gaussian. When diffracted into the substrate, it can be collimated and propagate in a conformal manner, with a diameter in the order of tens of micrometers or even over a hundred micrometers, thus obtaining a large alignment tolerance. The larger and collimated spot size allows for a larger alignment tolerance and enables alignment by passive methods. The collimating grating can be arranged in a one-dimensional or two-dimensional array to satisfy the input/output port requirements of the optical chip 100.

Since grating diffraction will inevitably also be emitted to the front surface of the optical chip 100, a layer of metal high-reflection film is deposited on the front surface of the optical chip 100 as the metal reflector 104, thereby avoiding the stepped blazed grating tooth surface requiring two-step etching in a more complicated process, and improving diffraction directivity and emission efficiency from the back surface. The metal reflector 104 has a certain distance from the collimating grating array 101, so that the light directly diffracted by the collimating grating array 101 towards the back surface and the light diffracted upward by the collimating grating array 101 and then reflected by the metal reflector 104 can be constructive and coherent, so that the light emitted from the collimating grating array 101 towards the back surface is the strongest, and thus the coupling efficiency of the light emission is improved. Similarly, the metal reflector 104 may be provided at the receiving end, so that the incident light received by the collimating grating array 101 is the strongest, and the coupling efficiency of the received light is improved.

The total internal reflection microprism 200 is attached to the back surface of the optical chip 100 at the position in which the collimating grating array 101 is aligned, and the hypotenuse of the total internal reflection microprism 200 totally reflects the incident light, and the collimated light propagating to the back surface of the optical chip is steered into collimated light propagating parallel to the plane of the optical chip, and is aligned with the optical fiber array 301. Therefore, the hypotenuse angle of the total internal reflection microprism 200 is determined according to the light emission angle of the collimating grating array 101. The two right-angle sides of the total internal reflection microprism 200 are coated with optical antireflection films to reduce reflection, and the size of the total internal reflection microprism 200 is designed to cover the entire grating array. The material of the total internal reflection microprism 200 may be Si, quartz, glass, or the like.

In this embodiment, the optical fiber array 301 and the collimating grating array 101 are configured with the same spacing. The optical fiber array 301 may be a single unit or a one-dimensional array, or it may be a two-dimensional array, as determined by the collimating grating array 101. The number of optical fibers in the optical fiber array is determined by the number of collimating grating arrays 101.

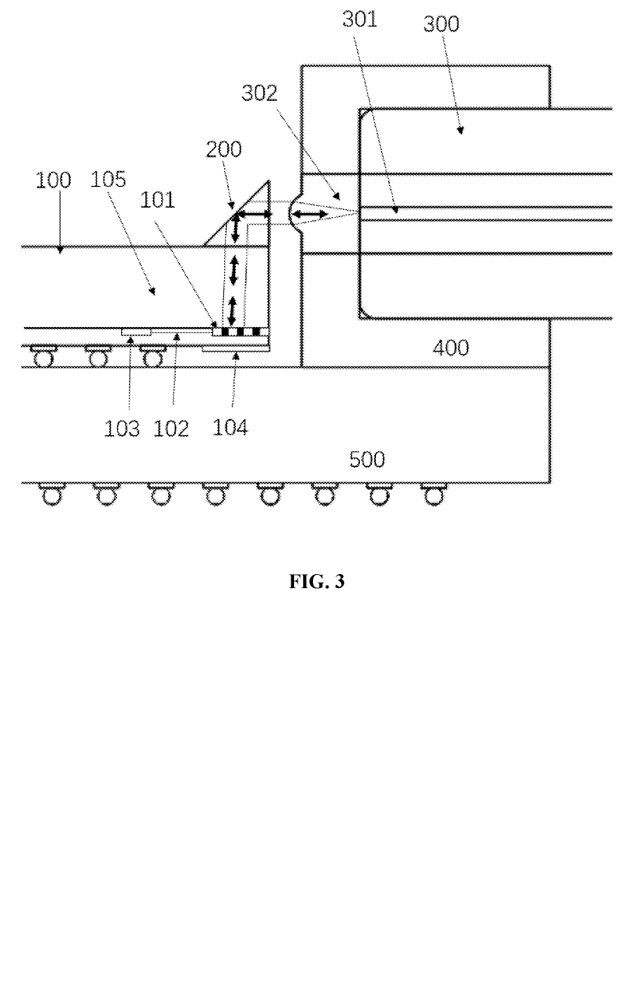

According to the above, the optical chip-fiber coupler optical path in this embodiment is shown in FIG. 3, and the operating direction of the optical path includes forward and reverse routes. When the optical connector 300 is inserted into the optical interface socket 400, the light output by the optical chip 100 from the output optical waveguide 102 array is first diffracted into collimated light by the collimating grating array 101, penetrates the substrate 105 and propagates to the back surface of the optical chip 100, and then is steered into collimated light propagating parallel to the optical chip plane through the total internal reflection microprism 200, and is aligned with the optical chip array 301, finally the microlens array 302 focuses the collimated light and couples it into the optical fiber array 301; similarly, when the light is operated in the opposite direction, the light is emitted from the optical fiber array 301, collimated by the microlens array 302, reflected by the total internal reflection microprism 200 on the back surface of the chip, penetrates the substrate 105 and is incident on the collimating grating array 101 of the optical chip 100, and then diffracted and coupled to the input optical waveguide 102 of the optical chip 100 by the grating array.

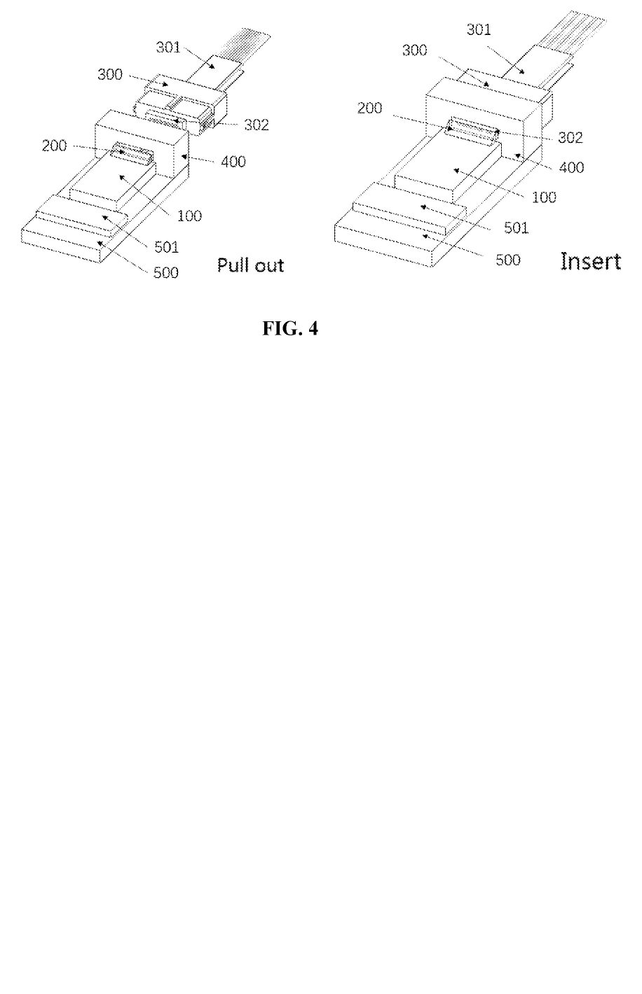

The optical connector socket 400 is mounted on the package substrate 500 of the packaged optical chip 100, allowing the optical fiber array 301 to be flexibly plugged in or fixed to the package substrate via the optical fiber connector 300. The pluggable coupling process is shown in FIG. 4. When the optical fiber connector 300 is inserted, it is accurately fixed in place so that its positional error satisfies the alignment tolerance of the collimated light emitted from the collimating grating array 101 coupled to the optical fiber connector 300.

The package substrate 500 may allow the optical chip 100 to be flip-chip mounted on the package substrate for fan-out packaging, enabling the various optical devices of the optical chip to be arranged in a two-dimensional array. The package substrate 500 may co-package the electrical chip 501 and the optical chip 100. The package substrate 500 can be made of materials such as silicon, glass, ceramic, and organic materials. Additionally, the package substrate 500 can be stacked and packaged in multiple ways and layers to achieve optimal optoelectronic performance.

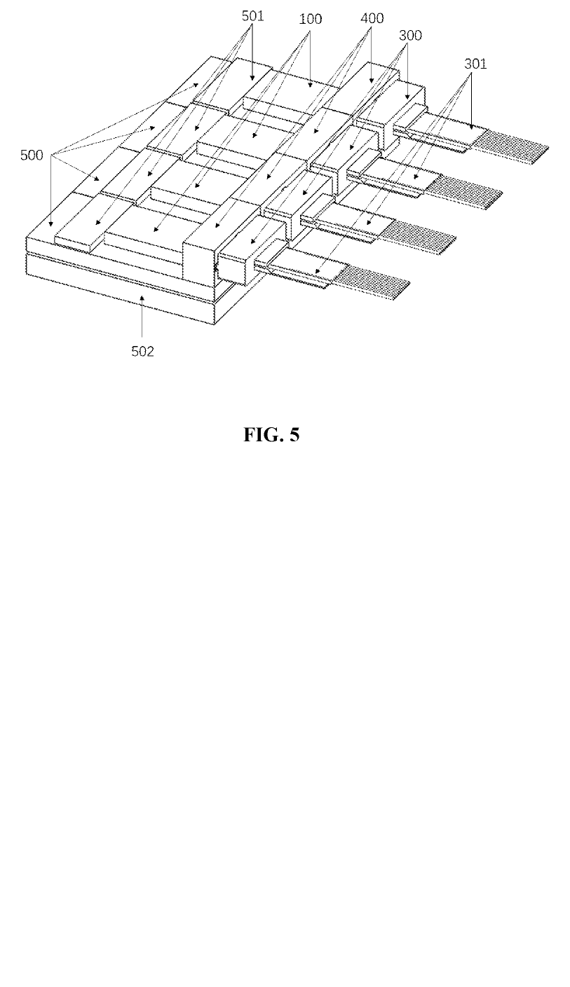

Multiple optical fiber pluggable optical interfaces can be packaged on a larger package substrate 502 or printed circuit board (PCB) to form an array as shown in FIG. 5, which is used in CPO and other application scenes.

### Embodiment 2

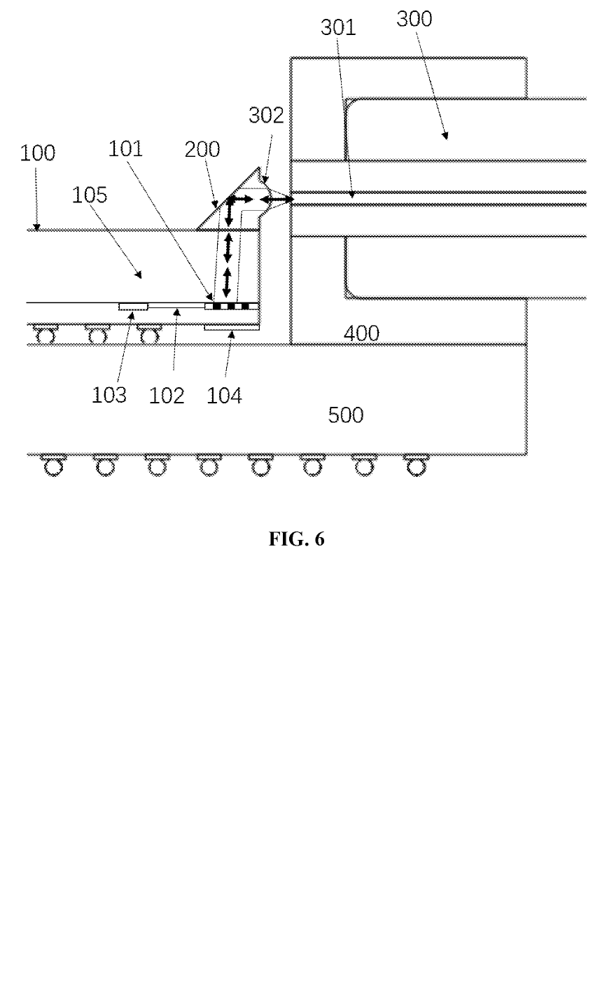

The microlens array 302 in the above-mentioned embodiment 1 can be integrally fabricated on the total internal reflection microprism 200, as shown in FIG. 6, and the end face of the optical fiber array 301 of the optical connector 300 is not attached to the microlens array 302. In this embodiment, when the optical fiber connector 300 is inserted into the optical interface socket 400, the light output by the optical chip 100 from the output optical waveguide 102 array is first diffracted into collimated light by the collimating grating array 101, penetrates the substrate 105 and propagates to the back surface of the optical chip 100, and then is reflected by the hypotenuse of the total internal reflection microprism 200 and steered into collimated light propagating parallel to the optical chip plane, when the light emitted from the total internal reflection microprism 200, it is focused and coupled to the optical chip array 301 by the microlens array 302 on the surface; similarly, when the light is operated in the opposite direction, the light emitted from the optical fiber array 301 to the microlens array 302 on the surface of the total internal reflection microprism 200, is collimated, then is reflected by the total internal reflection microprism200, penetrates the substrate 105, and is incident on the collimating grating array 101 of the optical chip 100, and then is diffracted and coupled to the input optical waveguide 102 of the optical chip 100 by the grating array. Wherein the optical fiber array 301 and the microlens array 302 may be a unit, a one-dimensional linear array, or a two-dimensional area array.

### Embodiment 3

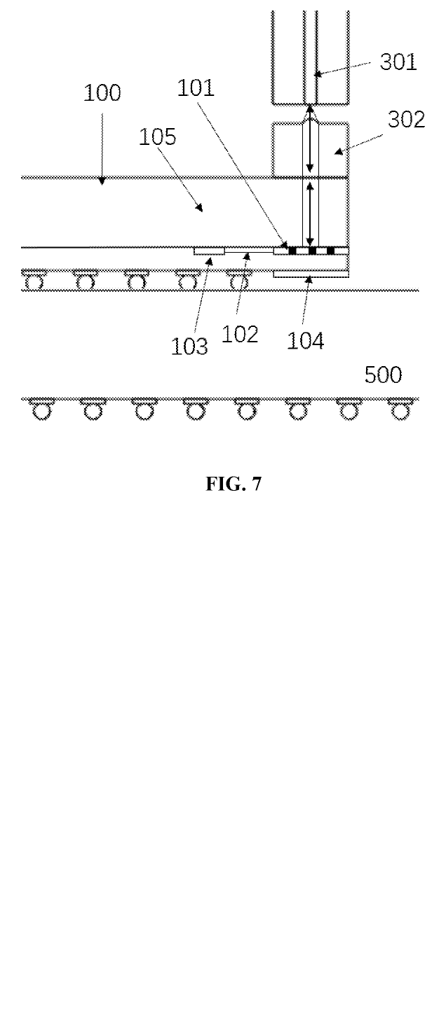

The microlens array 302 in the above embodiment 1 is attached to a position on the back surface of the optical chip 100 that aligns with the collimating grating array 101, and its internal structure is shown in FIG. 7. In this embodiment, the optical chip 100 and the optical fiber array 301 are arranged in a geometric relationship of vertical coupling, and there is no need to additionally arrange the total internal reflection microprism. The light output by the optical chip 100 from the output optical waveguide 102 array is first diffracted into collimated light by the collimating grating array 101, penetrates the substrate 105 and propagates to the back surface of the optical chip 100, and then is focused and coupled to the optical fiber array 301 through the microlens array 302; similarly, when the light is operated in the opposite direction, the light emitted from the optical fiber array 301 to the microlens array 302 is collimated, penetrates the substrate 105, and is incident on the collimating grating array 101 of the optical chip 100, and then is diffracted and coupled to the input optical waveguide 102 of the optical chip 100 by the grating array. Wherein the optical fiber array 301 and the microlens array 302 may be a unit, a one-dimensional linear array, or a two-dimensional area array.

Therefore, the present disclosure adopts the optical chip-fiber coupler based on the through-substrate collimating grating, and provides a through-substrate chirped collimating grating for coupling between optical fiber and optical chip. The collimating grating or grating array is used together with the total internal reflection microprism and the microlens array to collimate light beams into parallel light for coupling, thereby solving the problems of low coupling efficiency and small alignment tolerance in conventional grating coupling or end-face coupling. The optical interface socket on this configuration enables pluggable and efficient coupling between the fiber array and the optical chip. By implementing back surface light coupling from the optical chip, the optical device layout of the flip-chip mounted optical chip on the fan-out substrate is not constrained by the positions of light output ports or electrical interfaces, allowing free two-dimensional array arrangement. Both the edge density of the optical chip coupled fiber and the integration degree of the optical chip are improved.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. An optical chip-fiber coupler based on a through-substrate collimating grating, comprising: a package substrate; wherein a flip-chip mounted optical chip is arranged on the package substrate, wherein the optical chip comprises at least one optical device, an optical waveguide array for input and output functions, and a collimating grating array, wherein the collimating grating array is provided with gradient periods and duty cycles, so that light output from the optical waveguide array is diffracted toward the substrate through the collimating grating array, and the light propagates to a back surface of the optical chip in a collimated manner with a large spot size, thereby offering a large coupling tolerance, wherein an optical coupling element array is arranged on the back surface of the optical chip at positions corresponding to light emission from the collimating grating array to couple the light to an optical fiber array;
wherein the optical chip and the optical fiber array comprise a horizontal coupling relationship, wherein the optical coupling element array comprises a total internal reflection microprism and a microlens array arranged on a light emission path of the total internal reflection microprism;
wherein the optical coupling element array and optical fiber array may be connected to the package substrate through a mechanical structure, and the mechanical structure comprises an optical fiber connector arranged outside the optical fiber array and an optical interface socket on the package substrate;
wherein the optical fiber connector may be detachably connected to the optical interface socket, and wherein the large coupling tolerance of the collimating grating array allows the optical chip-fiber coupler to tolerate a large position error of the optical fiber array when the fiber connector is detachably connected to the optical interface socket.

2. The optical chip-fiber coupler based on a through-substrate collimating grating according to claim 1, wherein the microlens array corresponds to the optical fiber array and is configured as a single unit, a one-dimensional array, or a two-dimensional array.

3. The optical chip-fiber coupler based on a through-substrate collimating grating according to claim 1, wherein the package substrate is made of Si, quartz, glass, ceramic or organic material, wherein a plurality of electrical chips are arranged on the package substrate.

4. The optical chip-fiber coupler based a on through-substrate collimating grating according to claim 1, wherein when the optical fiber connector is inserted, a positional error of the optical fiber array satisfies the coupling tolerance with the collimating grating array.

5. The optical chip-fiber coupler based on a through-substrate collimating grating according to claim 1, wherein, the material of the optical chip is configured as InP, SOI, SiN, or thin-film lithium niobate, wherein types of optical devices comprise lasers, optical amplifiers, optical modulators, optical detectors, and multiplexers/demultiplexers, and wherein a back surface of the optical chip substrate is coated with an optical antireflection film.

6. The optical chip-fiber coupler based on a through-substrate collimating grating according to claim 1, wherein the collimating grating array is configured as a one-dimensional array or a two-dimensional array, wherein the collimating grating array is specifically a chirped grating, wherein a gradient grating coupling coefficient is obtained by optimizing a grating etching depth and the gradient duty cycle, thereby enabling the coupled outgoing or incident light to exhibit a specific optical field distribution.

7. The optical chip-fiber coupler based on a through-substrate collimating grating according to claim 1, wherein a metal high-reflection film is deposited on the surface of an upper cladding layer of the collimating grating array as a metal reflector, and wherein a distance between the metal high-reflection film and the collimating grating is adjusted, so that light diffracted from the collimating grating array to the upper cladding and reflected by the metal high-reflection film and then penetrated the collimating grating array constructively interferes with the light diffracted directly downward to the substrate by the collimating grating array.

8. The optical chip-fiber coupler based on a through-substrate collimating grating according to claim 1, wherein material of the total internal reflection microprism is Si, quartz or glass, wherein a reflection surface of the total internal reflection microprism is arranged at a hypotenuse and totally reflects light, and an angle of the hypotenuse satisfies a condition that the light emission from the collimating grating array is steered to be parallel to a plane of the optical chip and aligned with the optical fiber array; wherein the two right-angle sides of the total internal reflection microprism are coated with optical antireflection films, and a projection area of the total internal reflection microprism along the light beam propagation direction covers the collimating grating array.

9. The optical chip-fiber coupler based on a through-substrate collimating grating according to claim 2, wherein the microlens array is attached to an end face of the optical fiber array or arranged on the total internal reflection microprism, and the microlens array focuses and couples the collimated light emitted from the optical chip into the optical fiber array.

10. The optical chip-fiber coupler based on a through-substrate collimating grating according to claim 2, wherein the microlens array is integrally fabricated on the back surface of the optical chip substrate, and the microlens array focuses and couples the collimated light emitted from the optical chip into the optical fiber array.
